(19) United States
(12) Patent Application Publication
(10) Pub. No.: US 2026/0278080 A1
(43) Pub. Date: Sep. 17, 2026

(54) SYSTEM AND METHOD FOR RANSOMWARE DETECTION UTILIZING POWER SIDE-CHANNELS AND MACHINE LEARNING

(71) Applicant: Robert Bosch GmbH, Stuttgart (DE)

(72) Inventors: Sashidhar JAKKAMSETTI, Sunnyvale, CA (US); Pradeep M. PAPPACHAN, Pittsburgh, PA (US); Jorge GUAJARDO MERCHAN, Pittsburgh, PA (US); Stefan GEHRER, Pittsburgh, PA (US); Sekar KULANDAIVEL, Pittsburgh, PA (US); Shalabh JAIN, Pittsburgh, PA (US)

(21) Appl. No.: 19/079,744

(22) Filed: Mar. 14, 2025

(51) Int. Cl. G06F 21/55

(52) U.S. Cl. CPC G06F 21/554; G06F 2221/034

(57) ABSTRACT

A method for detecting ransomware includes receiving training data with side-channel power trace information from one or more training devices, preprocessing the training data, sending the one or more frequency-time representations to an embedding model including a convolutional neural network configured to output one or more fixed-size embedding vectors utilizing the one or more frequency-time representations, sending a consecutive set of the one or more fixed-size embedding vectors to a sequence model including a machine learning network configured to handle sequential data and further configured to output one or more probabilities indicating the consecutive set as benign or malicious, sending, to a machine learning model, a continuous sequence of one or more probabilities from machine learning network configured to handle sequential data to output a final trained architecture to output a final decision probability indicating ransomware presence.

### TECHNICAL FIELD

The present disclosure relates to security of a computer system, including such a computer system that includes an intrusion detection systems for protecting against encryption-based malware.

### BACKGROUND

Ransomware presents a serious threat to modern digital systems, causing substantial financial and operational damage. In recent years, it has become one of the most infamous forms of malware, targeting individuals, governments, and businesses alike. For cybercriminals, ransomware has evolved into a highly profitable enterprise, generating millions in revenue, while for organizations, it poses a significant risk, leading to financial losses that amount to billions of dollars.

With the advancement of information technology, real-world assets (e.g. data with sensitive information) are increasingly moving into cyberspace. Consequently, ransomware has become a major cybersecurity threat, with a significant surge in attacks in 2024. Recent reports indicate that over 300 million ransomware attempts were made in 2023, affecting 65% of surveyed organizations worldwide. Total ransomware payments exceeded a billion dollars that year, marking the highest ever recorded. From the infamous WannaCry, which impacted more than 200,000 computers in over 150 countries, to the recent ransomware attack on Japanese entertainment giant Kadokawa that disabled Japan's largest video-sharing platform, Niconico, for a month, ransomware remains a persistent threat. In January 2024, Lurie Children's Hospital in Chicago was attacked by the Rhysida ransomware group, which earned over $3 million from selling stolen data. The hospital took nearly a month to recover. Government sectors are also frequent targets. The City of Baltimore spent over $18 million recovering from a ransomware attack that crippled municipal operations, and the U.S. energy sector was hit when a fuel pipeline was taken down, forcing a $5 million ransom payment to resume operation. These examples of ransomware highlight the need for effective mitigation strategies.

While traditional detection methods like signature-based approaches and behavioral analysis have been employed, those approaches often struggle to detect sophisticated ransomware or prevent attacks early enough. Machine learning has improved detection, but still faces challenges from evolving threats.

### SUMMARY

According to a first embodiment, a computer-implemented method for detecting ransomware on one or more target devices includes receiving training data from one or more training devices, wherein the training data includes side-channel power trace information associated with side-channel measurements from the one or more training devices, preprocessing the training data, wherein the preprocessing includes sending the training data to a low-pass filter configured to remove abnormalities associated with the side-channel power trace information, cut each trace into a plurality of consecutive frames, and converting each of the plurality of frames into a one or more frequency-time representations, sending the one or more frequency-time representations to an embedding model including a convolutional neural network configured to output one or more fixed-size embedding vectors utilizing the one or more frequency-time representations, sending a consecutive set of the one or more fixed-size embedding vectors to a sequence model including a machine learning network configured to handle sequential data and further configured to output one or more probabilities indicating the consecutive set as benign or malicious, sending, to a machine learning model, a continuous sequence of one or more probabilities from machine learning network configured to handle sequential data, wherein the machine learning model is configured to adjust parameters associated with the embedding model, the sequence model, and the machine learning model to output a final trained architecture output a final decision probability indicating ransomware presence in response to exceeding a probability threshold, wherein the final trained architecture is stored in a model database at a ransomware device, receiving, at the ransomware device, real-time data from the one or more target devices in communication with the machine learning model, wherein the real-time data includes power trace information associated with the one or more target devices, in response to comparing the real-time data to the model database, determining whether ransomware activity has occurred, and in response to detecting ransomware activity occurring, executing a counterattack, wherein the counterattack includes shutting down operation at the one or more target devices.

According to a second embodiment, a computer-implemented method for detecting ransomware on one or more target devices includes receiving, utilizing a power measurement device, real-time data from one or more devices, wherein the real-time data includes side-channel power trace information associated with side-channel measurements from the one or more devices, preprocessing the real-time data, wherein the preprocessing includes sending the real-time data to a low-pass filter configured to remove abnormalities associated with the side-channel power trace information, cut each trace associated with the real-time data into a plurality of consecutive frames, and converting each of the plurality of frames into a one or more frequency-time representations, sending the one or more frequency-time representations to an embedding model including a convolutional neural network configured to output one or more fixed-size embedding vectors utilizing the one or more frequency-time representations, sending a consecutive set of the one or more fixed-size embedding vectors to a sequence model including a machine learning network configured to handle sequential data and further configured to output one or more probabilities indicating the consecutive set as benign or malicious, sending, to a machine learning model, a continuous sequence of one or more probabilities from the machine learning network configured to handle sequential data, outputting a final decision probability indicating ransomware presence in response to the continuous sequence of one or more probabilities exceeding a probability threshold, and in response to the machine learning model detecting ransomware activity occurring, executing a counterattack at the one or more devices and recovering one or keys associated with the ransomware.

According to a third embodiment, a computer-implemented method for detecting ransomware on one or more target devices includes receiving, utilizing a power measurement device, real-time data from one or more devices, wherein the real-time data includes side-channel power trace information associated with side-channel measurements from the one or more devices, converting the side-channel power trace information to one or more Mel spectrograms, sending the one or more frequency-time representations to an embedding model including a convolutional neural network configured to output one or more fixed-size embedding vectors utilizing the one or more frequency-time representations, wherein the convolutional neural network is further configured to utilize a consecutive set of the one or more fixed-size embedding vectors to output one or more probabilities indicating the consecutive set as benign or malicious, sending, to a machine learning model, a continuous sequence of one or more probabilities from the convolutional neural network neural, wherein the machine learning model is configured to output a final decision probability indicating ransomware presence in response to exceeding a probability threshold and in response to detecting ransomware activity occurring, output an indication of ransomware activity at the one or more devices.

### BRIEF DESCRIPTION OF THE DRAWINGS

FIG. 1 illustrates a block diagram of an exemplary computing device according to one embodiment of the disclosure.

FIG. 2 illustrates an overview of a system and method according to one embodiment.

FIG. 3 illustrates an embodiment of a detection workflow utilizing the system and method described below.

FIG. 4 illustrates an embodiment of trace during a preprocessing stage.

FIG. 5 illustrates an embodiment of a detection architecture.

FIG. 6A is an example of a real-time sliding window-based detection mechanism after a first time period. Such a time period may be one second after a ransomware infection.

FIG. 6B is an example of a real-time sliding window-based detection mechanism after a second time period.

FIG. 7 illustrates an alternative embodiment of an architecture including a model that can be transfer learned.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Although there is extensive work on mitigating ransomware, most solutions have some shortcomings. For example, many systems and techniques rely on the operating system (OS) to host trusted modules for detecting or recovering from ransomware. However, recent ransomware variants (such as LockBit) can detect and evade or disable these anti-ransomware solutions, leaving the victim system vulnerable. Thus, assuming the OS kernel is trusted is increasingly considered a strong and potentially impractical assumption.

Many techniques require modifications to the OS kernel to integrate their trusted modules. This is not always feasible, as some operating systems are proprietary and may impose strict restrictions on third-party changes. Furthermore, much of the prior work is not generalizable across different devices and platforms, as they are often platform-specific (e.g. work with Windows platforms, while some may work exclusively on SSDs).

Many approaches also depend on signals from the OS, such as application program interface (“API”) calls, network activity, system calls, and file input/outputs (“I/O”), to detect suspicious activity and flag it as ransomware. If ransomware detects such monitoring, it can disguise its signals as benign processes, potentially reducing detection accuracy and leading to noticeable false positive rates.

In this disclosure, the system proposes an embodiment that is a practical (yet powerful) method and system for early detection of ransomware using power side channels and deep learning techniques, including those from a machine learning model. By analyzing the power consumption patterns of a target machine, it is possible to identify with high probability if there is ransomware-like process running on the machine. One or more embodiments may illustrate a new way to identify and learn such power patterns, enabling detection of ransomware at real-time while the machine is operating in a proactive manner.

One advantage of the embodiment below is the preprocessing aspect. With the preprocessing, one or more illustrative embodiments may employ a profiling-based side-channel analysis technique. This may include a processor or controller that is programmed or configured to convert 1D signal data into modified Mel spectrograms—a 2D input, which are processed by a machine learning (“ML”) pipeline to identify ransomware activity. This method yields high accuracy, as ransomware—particularly during file encryption—produces distinct patterns in a certain frequency range (precisely between 2 KHz and 16 KHz) of the spectrogram, making it easier to differentiate from benign workloads.

The system also includes an advantage with its detection pipeline. For example, the system and method may be built or executing utilizing a robust classification machine learning (ML) model, which operates in three (or more stages). In a first stage, the system may utilize a Convolutional Neural Network (CNN) in one embodiment, however, any type of neural network may be utilized that can capture localized spatial and timing relationships and correlations from inputs. For example, there can be use of such networks include Wavenet CNNs, Transformers, Convolutional LSTMs (ConvLSTMs), Convolutional Recurrent Neural Networks (CRNNs), Recurrent Neural Networks (RNNs), Bidirectional RNNs (BRNNs), and Deep Belief Networks (DBNs) itself in any of the stages. The Wavenet 2D Convolutional Neural Network (CNN) model may process the modified 2D Mel spectrograms as input and outputs fixed-size 1D embedding vectors. During a second stage, the system may include a sequence of consecutive frame embedding vectors that is then fed into a Long Short-Term Memory (LSTM), Recurrent Neural Network (RNN), or Transformer model which analysis the temporal features and patterns across the sequences and outputs the probability of these frames being malicious. Then during a third stage, a set of consecutive such probabilities is passed into ML models (for example, XGBoost), which outputs the likelihood that the frames originate from a malicious signal, indicating ransomware activity. However, any type of classifier (not only XGBoost) can be implemented, such as a binary classifier or a fully-connected layer combined with a Softmax layer. This third stage allows the model to adapt to the behavior of the ransomware and for certain ransomware to detect it faster than any similar prior art methods. In particular, the first stage model outputs detection embeddings every few miliiseconds, the second stage model outputs detection probabilities every few seconds and the third stage processes a window of this continuous detection as to provide a high level of confidence by aggregating the information from all these continuous frames. This is in contrast to previous art that output a single decision (yes/no) from a longer frame, which generally leads to a higher false positive rate.

There are several advantages of the embodiments disclosed below as compared to the prior art. In one example, the preprocessing step may convert time-domain signals into modified Mel spectrograms within a specific frequency band. Various experiments demonstrated that Mel spectrograms within this frequency range provide high distinguishability between ransomware and other benign processes, even when the signal data collected is AC power (instead of DC power which has much lesser noise). As a result, Mel spectrograms, combined with the Wavenet 2D CNN model, output embedding vectors that reveal distinct patterns for ransomware frames, enabling the rest of the pipeline to achieve highly accurate results. This high accuracy is crucial because our goal is to maintain a high true positive rate (detecting ransomware when it is a real attack) while keeping the false positive rate (falsely identifying ransomware in benign scenarios) very low.

Since the embodiments of the system and method relies on side-channel measurements that can be obtained without accessing internal components, it operates independently of the target machine's operating system. As a result, it is not vulnerable to ransomware capable of compromising the OS or evading detection mechanisms. Specifically, the system and method cannot be affected by any remote adversary without physical access to the target machine. Additionally, it requires no modifications to the target's software, including the OS, hypervisor, or firmware, making it applicable to any device that consumes power (irrespective of the platform and hardware used).

Due to its design, the system may remain completely undetectable by ransomware attacking the target machine. Ransomware cannot evade this detection because it must execute file encryption in some, which is precisely what the embodiments of the system and method disclosed below monitors. This ensures that attackers cannot hide their activity patterns.

The system and method may features multiple stacked ML models that can be independently learned and updated. This modular approach allows for partial model updates when new ransomware variants are discovered or benign workloads evolve, ensuring continued detection accuracy without the need to modify the entire pipeline, which could otherwise be computationally expensive. This also results in improved model training times (since only certain models need to be updated, the overall time to train is reduced)

The system and method may further run on resource-constrained embedded devices, such as Raspberry Pi or Sabrelite, because the ML models used in the architecture are lightweight machine learning models (e.g. requiring less than 100 MB of memory). The models can also be further reduced in size, depending on the device requirements. This flexibility allows the system and method to run locally, near the target device. This enables immediate physical intervention if ransomware is detected, without the need to send data to a central server. This avoids round-trip delays caused by network communication.

In contrast to prior systems, the system and method disclosed below may require sub-megahertz sampling, and much lower sampling rate than the frequencies of the processes being monitored in the device under observation (traditional signal processing theory would indicate that one should sample at least twice the frequency of the signals being monitored).

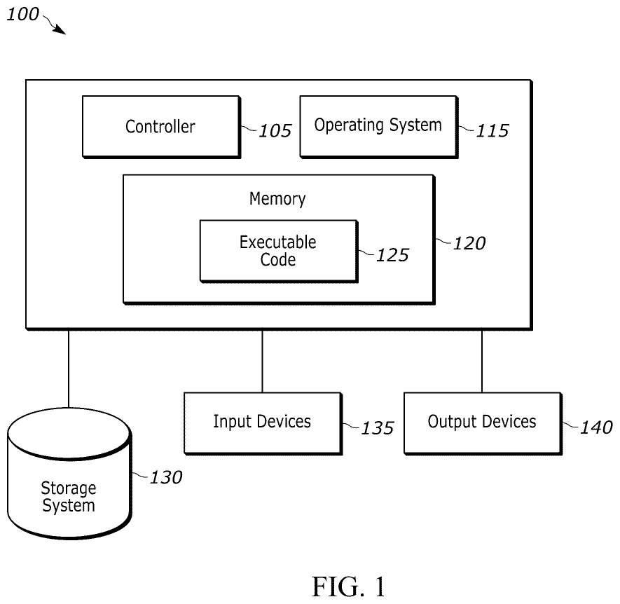

FIG. 1 illustrates a block diagram of an exemplary computing device according to one embodiment of the disclosure. As shown in FIG. 1, a device 100 may include a controller 105 that may be, for example, a central processing unit (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a nonvolatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that enforces security in a vehicle as further described herein, for example, detects or prevents cyber-attacks on in-vehicle networks. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. Where applicable, the terms “process” and “executable code” may mean the same thing and may be used interchangeably herein. For example, verification, validation and/or authentication of a process may mean verification, validation and/or authentication of executable code.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a nonvolatile memory having the storage capacity of storage system 130. Accordingly, although shown as a separate component, storage system 130 may be embedded or included in memory 120.

Input devices 135 may be or may include any suitable input devices, components or systems, e.g., physical sensors such as accelerometers, tachometers, thermometers, microphones, analog to digital converters, etc., a detachable keyboard or keypad, a mouse and the like. Output devices 140 may include one or more (possibly detachable) displays or monitors, motors, servo motors, speakers and/or any other suitable output devices. Any applicable input/output (I/O) devices may be connected to computing device 100 as shown by blocks 135 and 140. For example, a wired or wireless network interface card (NIC), a universal serial bus (USB) device, JTAG interface, or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate, with control or other units in a vehicle, e.g., input and/or output devices or components 135 and 140 may include ports that enable device 100 to communicate with an engine control unit, a suspension control unit, a traction control and the like.

Embodiments may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as computing device 100.

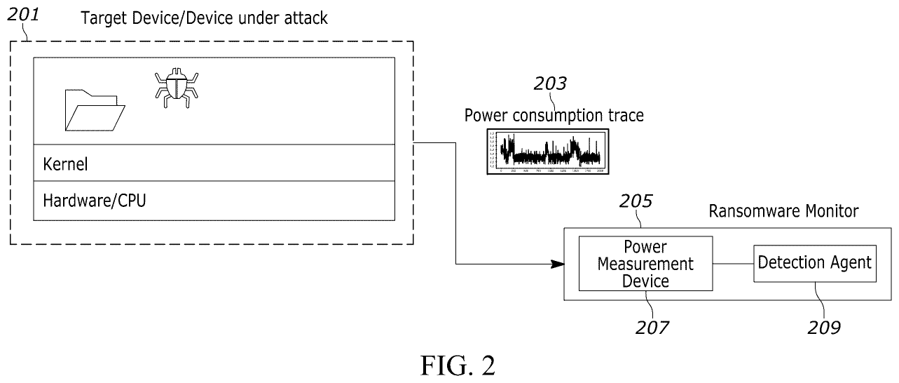

FIG. 2 illustrates an overview of a system and method according to one embodiment. The system and method may include a target device 201. The target device 201 may be the device under attack. The target device 201 may include various hardware and software components, such as those discussed in FIG. 1. The target device 201 can be any computing device, such as a desktop/PC, mobile phone, server, enterprise high-performance server, industrial control system, IoT device, or automotive microcontroller-essentially, any device that relies on a power source, whether from an outlet or battery. The ransomware monitor 205 is a specialized device equipped with a power measurement tool 207, such as an oscilloscope or electromagnetic (EM) measurement device, to track the target device's power consumption 203 (or EM, sound, etc., any side-channel information; hereafter the system and embodiments may describe the system for power traces, however any form of signal can be considered as a source). The ransomware monitor 205 may include a processor to read and analyze digital power traces and a small storage unit for storing pre-trained ML models that analyze the power data to detect ransomware. The monitor and target device are physically close to enable real-time measurement and monitoring.

The system may assume that all software components on the target device 201 (e.g. including the OS, hypervisor, and driver software/firmware), can be compromised, and ransomware can operate at any privilege level. Physical adversaries with direct access to the target device 201 are not considered. The ransomware monitor 205 is assumed to be trusted and physically unreachable by adversaries or unauthorized parties. For additional security, the monitor is offline, without network access, to prevent remote attacks. However, if the ransomware monitor 205 is equipped with a secure root of trust, such as a trusted platform module (TPM) or a trusted execution environment (TEE), network communication could be allowed after proper authentication, the system can further enable secure boot and attestation processes to ensure the integrity of the monitor's software and models.

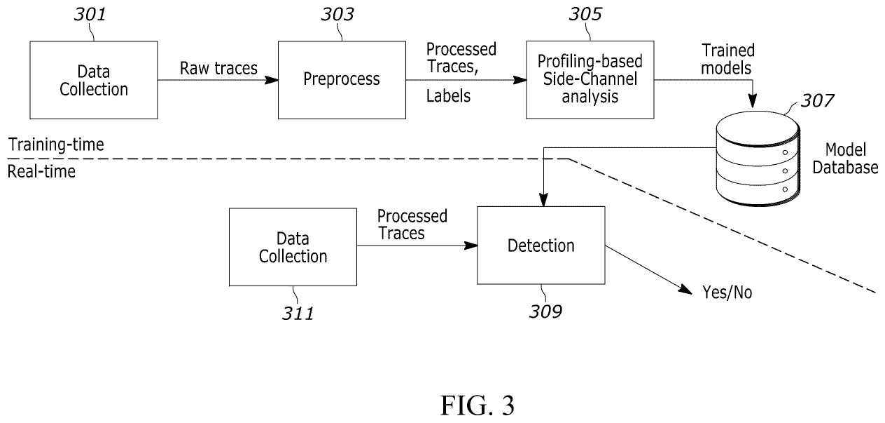

FIG. 3 illustrates an embodiment of a detection workflow utilizing the system and method described below. One of the core component of an embodiment of the system and method may be the detection pipeline that is responsible to detect ransomware given a power trace. The key aspect of the pipeline is the side-channel analysis, which detects patterns in the power trace indicative of ransomware activity, specifically focusing on file encryption and I/O processes.

As shown in FIG. 3, at a high-level there are two phases in this pipeline: (1) training phase and (2) real-time phase (e.g. run-time). In the training phase, at step 301 during the data collection step the system and method may collect sample data from a device similar to the target device. Thus, it may not be the exact same target device, but may be similar model, hardware components, or software components, etc. To build generalizable detection models, data collection should include data from a variety of devices. For instance, if the goal is to deploy the models on desktop systems, it is essential to gather data from different hardware processor types (e.g., Intel,AMD, and ARMprocessors) and platforms (e.g., Linux and Windows). This ensures the model is robust enough to detect ransomware across a wide range of desktop configurations. The more diverse the data collection, the better the detection accuracy across various systems.

Once the hardware and software environments are selected, the system and method may run sample benign processes (normal user activity) and malicious processes (ransomware) on each system, collecting thousands of power traces. The quantity and length of these traces depend on the desired accuracy-more data generally improves model performance. Additionally, malicious workloads should include benign processes to introduce intentional noise, training the models to detect ransomware even under high system utilization, where noise from normal operations is present.

At step 303, the system may preprocess the data that is collected from the similar device(s). Each power trace is first processed to remove abnormalities introduced during collection. This can occur in two phases, in one embodiment. The power trace may pass through a small low-pass filter to remove abnormalities introduced during measurement and other minor irregularities. Other types of filtering may be utilized to improve the data that is collected.

If reference variations in power grid supply frequency are available as measurements from a secondary device, such variations are removed from the power trace. This can be done by performing a band pass filtering of the reference variation signal to obtain the frequency offset waveform, and then subtracting the obtained waveform from the power trace.

Then each trace is cut into multiple consecutive frames, where each frame consists of a set of power samples for a short duration (e.g. 10 milliseconds). However, any time frame may be utilized. For example, other frame sizes might be used instead depending on the hardware platform and sampling rate that is used in our monitoring hardware. In some examples, if the processor in the monitoring device is slower, then the system may need to adjust the frame size to larger time periods (e.g., 30 msec, 100 msec, 200 msec, 1 sec, etc.). In another embodiment, if the processor is faster, than the system may utilize could use smaller frames (e.g., 1 msec or ½ msec, etc.) Of course, any time period may be utilized.

The idea is that each frame captures key operations of the ransomware process, such as symmetric key encryption of file chunks, reading and writing data to disk, deleting, or overwriting files.

Next, each frame is converted into Mel spectrograms in one embodiment. Spectrogram is a representation of frequency spectrum across small time intervals; these are used in signal processing to analyze the characteristics of a given signal such as an audio file. Mel spectrograms amplify lower frequencies using Mel filter banks and are commonly used in signal processing to analyze human voice or speech. While Mel spectrograms are utilized in one embodiment, one can use Mel-frequency cepstral coefficients (“MFCCs”). In addition, other frequency/time representations might also be advantageous or combined with these. For example, the system may utilize short-time Fourier transform (STFT), gammatone-frequency cepstral coefficients (GFCC), constant-q transform (CQT), and variable-q transform (VQT), wavelet transform, continuous wavelet transform, or any other type of similar processing. In our experiments, Mel spectrograms outperformed standard spectrograms because ransomware or encryption processes tend to exhibit distinct patterns in the mid-range frequency bands. Particularly between 2 KHz and 16 KHz ransomware frames and other benign frames show large distinguishability. The system may perform extensive cross-correlation analysis and used deep learning models to confirm this frequency band. The patterns exhibited in ransomware frames make it easier for machine learning models to accurately detect ransomware. Based on our observations, the system may benefit from using greater than or equal to 256 Mel filters when converting frames into Mel spectrograms for optimal performance. As in previous art, Mel spectrograms are but one example of a possible representation. Other possible representations might include one or several of Gramian Angular Field (GAFs), Markov Transition Fields (MTFs), Recurrence Plots (RPs), spectrograms using short Fourier transforms.

At step 305, the system and method may perform side channel analysis to train one or more models. These trained models, along with the detection software, are then installed on the Ransomware Monitor. The trained models may be fed to a model database that includes information regarding normal activity and potential ransomware activity. The model database may be utilized to identify suspicious activities. These could be combined with a standard transformer in a Retrieval Augmented Generation system (RAG), which could contain other side-channel information relevant to the identification of different and/or known ransomware variants.

During deployment, the monitor is connected to the target device to capture real-time power samples at the data collection step 307. The monitor uses the trained models to analyze these power traces and detect ransomware activity at step 309. If ransomware is detected with high confidence, the monitor alerts the device operator and may shut down or suspend the device to prevent further damage. The notifications may include messages sent to the devices or third-party devices. Other counterattacks or countermeasures may include shutting down the device, running specific software to combat the ransomware, or locking certain hardware/software components of the target device.

At step 311, the system and method may collect real-time data from various devices. The system and method may collect samples in real-time from one or more target devices, including when a ransomware attack is occurring. The data may be include the side-channel measurements discussed above.

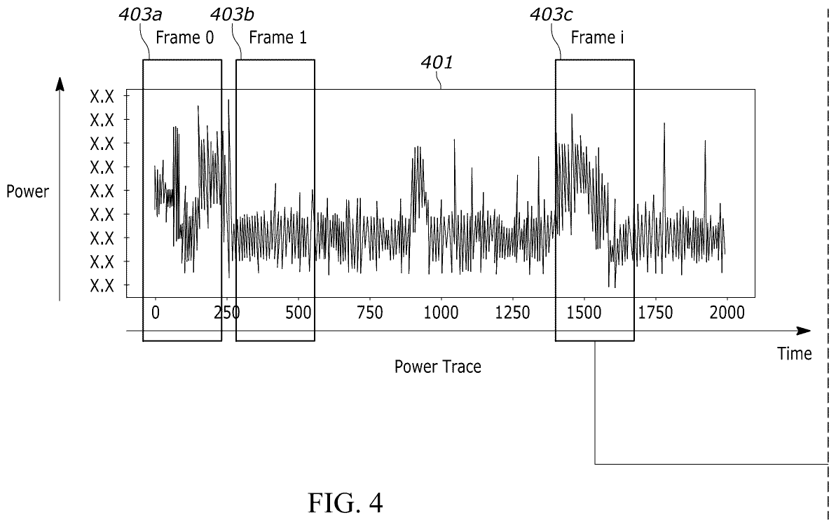

FIG. 4 illustrates an embodiment of trace during a preprocessing stage. The preprocessing stage may be before feeding into a main detection pipeline. Power trace 401 may be an example of a power trace output (e.g. spectrogram) by a Mel spectrogram over time. The power trace output 401 may include individual frames 403a, 403b, 403d, etc. A shown, the power trace spectrogram may define power over time. The power trace may be analyzed by various frames 403 over time, such as frame 0, frame 1, . . . ‘frame i.

Other system may have utilized slicing traces into frames and converting them into Mel spectrograms. While some systems and method may implemented Mel spectrograms, however, in this disclosure the system and method may specify a particular sampling frequency and the associated range of frequency band that is useful in distinguishing ransomware.

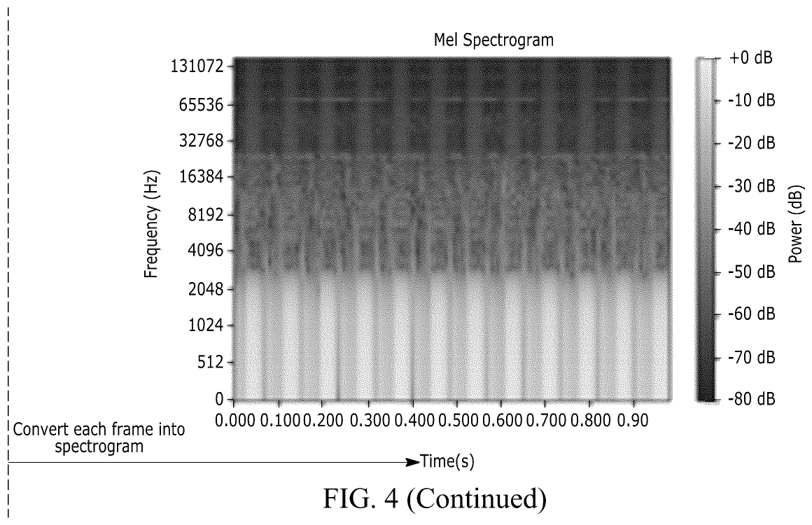

FIG. 5 is an embodiment of a detection architecture. The model training architecture may be associated with profiling-based side channel analysis. With a consecutive sequence of frames converted into Mel spectrograms, the system may perform the following model training described below. As shown below, a number of different machine learning models may be consecutively utilized in the detection architecture. This includes an embedding model 503, a sequence model 505, a window model 507, and a decision model 509.

The embedding model 503 may be a convolutional neural network (CNN), (Wavenet 2D) in one model that receives a plurality of pictograms of frames 501a, 501b, 501c, 501d, 501e, 501f, 501g. Each Mel spectrogram is converted into a fixed size embedding vector output by the embedding model 503. This is a process of dimensionality reduction that condenses the 2D spectrogram into a 1D vector. The embedding model 503 may be utilized to train using supervised learning, where input spectrograms (e.g. 501a) are labeled as benign (0) or malicious (1), based on the workload they originated from during the data collection phase. The embedding model 503 may be a convolutional neural network (CNN), such as a Wavenet model, which is designed to capture both short- and long-term dependencies in the data to learn complex patterns. Wavenet models are commonly used in audio signal processing, using dilated filters in their CNN architecture. These filters modulate extended samples in the input array, ensuring that the next layer captures long-term patterns within the input. In our proposed approach, the system may use Wavenet to learn the cyclic patterns exhibited by ransomware, particularly due to its repetitive file I/O and encryption operations. The embedding model may also include an encoder layer that outputs the embedding for this stage. The full model is trained in a supervised manner, with the encoder layer connected to a classification model that aligns with the supervised labels. This ensures that the embeddings retain the necessary information to distinguish between benign and malicious spectrograms.

The next model may be a sequence model 505. A consecutive set of embedding vectors (coming from consecutive set of frames and then spectrograms) is fed into a sequence model 505, which outputs a probability indicating whether the sequence belongs to a benign or malicious trace. This sequence model can be any recurring neural network (RNN), such as a Long-Short-Term-Memory (LSTM) model, which is capable of correlating inputs sequentially. During training, the system may input all possible sequence of embeddings from all traces to train this model to output a single probability value.

The system may include a window model 507 and decision model 509. These models are simpler compared to the embedding and sequence models; for instance, in one example the system may utilized XGBoost ML models. However, any type of classifier can be implemented, such as a binary classifier or a fully-connected layer combined with a Softmax layer. The goal is to analyze a continuous sequence of probabilities produced by the sequence model to classify whether the trace is malicious. The output is a final decision probability indicating ransomware presence. The probability decision threshold can be adjusted depending on the desired trade-off between false positive and true positive rates (i.e., varying the threshold to control acceptable false positives while maintaining accurate ransomware detection).

While the use of CNNs and RNNs for malware/ransomware detection has been used in previous systems, the specific embodiments utilize CNNs and RNNs in this embodiment in a significantly different manner. In this system and method, one embodiment of the architecture may utilize a Wavenet CNN model to extract embeddings from the frame spectrograms, which are then fed into a Long Short-Term Memory (LSTM) model to learn whether there exist a pattern repeating across consecutive embeddings. This is distinct from previous models. Furthermore, the system and method may lead to increased detection accuracy by tying LSTM outputs across consecutive sequences of embeddings with an XG Boost model—an approach that has not been explored before for ransomware detection. However, any type of classifier can be implemented aside from the XG Boost model, such as a binary classifier or a fully-connected layer combined with a Softmax layer.

There may be some additional key features for embodiments associated with this architecture. Lower models, like the embedding model 503, process fewer frames at a time, with the embedding model 503 analyzing one frame and the sequence model processing a few frame embeddings. In contrast, the upper models process more frames to make a final decision. This is necessary to reduce false positives, as analyzing only a few frames might incorrectly identify benign processes (e.g., 7zip encryption) as ransomware. To ensure accuracy, the upper models require a broader view of multiple frames.

As the pipeline progresses to higher models, the complexity and number of parameters decrease. The lower models, like the embedding model 503, are denser because they need to capture fine-grained details in the spectrograms. Upper models, on the other hand, operate on simpler inputs like probabilities, which reduces their complexity.

There may be various embodiments of a propose architecture that can be used. For example if the embedding model 503 is capable of accurately predicting whether a frame is malicious, the sequence model may be unnecessary. In this case, the upper ML models could directly use the frame probabilities from the CNN model. This may reduce the runtime and memory overhead of the overall architecture, because RNNs are inherently sequential models that take longer time for inference.

The top ML model could be replaced by a simpler method, such as averaging the sequence model's outputs. Alternatively, the lower ML model could be given a larger input window to process more data directly. This also makes the overall architecture simpler and reduced runtime overhead.

If the embedding model can output probabilities for each frame indicating whether the frame is malicious or benign, Bayesian methods can be used to estimate the probability that a sequence of frames is malicious or benign. The system may observe evidence (E₀, E₁, . . . Eₖ of an attack (from the embedding model) at time:
instants t₀, t₁, . . . , tₖ, where Eᵢ is the evidence (from frame i) of an attack, according to the model; i.e., Eᵢ=1 if the model believes the frame belongs to an attack trace, and 0 otherwise. By Bayes' Theorem,

$$P ( Attack \vert {E}_{0} {E}_{1} … {E}_{k} ) = P ( {E}_{0} {E}_{1} … {E}_{k} \vert Attack ) P ( Attack ) / P ( {E}_{0} {E}_{1} … {E}_{k} ) .$$

In the above equation, P (Attack)=a priori probability of attack (a constant). For any k, P (E₀E₁ . . . Eₖ|Attack) is computed as follows from the training set Keep a count of # times the sequence E₀, E₁, . . . , Eₖ is observed in the set of attack traces Divide the above count by the total number instances of the sequence.

Finally,

$$P ( {E}_{0} {E}_{1} … {E}_{k} ) = P ( {E}_{k} \vert {E}_{k - 1} … {E}_{0} ) P ( {E}_{k - 1} \vert {E}_{k - 2} … {E}_{0} ) … P ( {E}_{2} \vert {E}_{1} {E}_{0} ) P ( {E}_{1} \vert {E}_{0} ) P ( {E}_{0} )$$

by applying the Chain Rule, where P(E₀) is the output of the model for frame 0; P (E₁|Eᵢ₋₁ . . . E₀) is the conditional probability of observing Eᵢ, given Eᵢ₋₁ . . . E₀ was observed prior to Eᵢ.

Thus, one can compute the probability of an attack given evidence from individual frames using just the embedding model followed by computation of conditional probabilities (obtained from training data). This could further reduce the size of the model that is stored on the detector device.

The architecture can be thoroughly modified to reduce its model parameters, thus reducing the memory/runtime overhead. If the target device exhibits strong ransomware patterns even with lower signal sampling rates, then the models can be made smaller (for example, the embedding model of FIG. 5 can be reduced from 36 MB to 2 MB by reducing the sampling rate by 10×)—this reduces the cost constraints on our detection device.

A possible variation is to substitute the LSTM section of this model, with one or multiple attention blocks as typically used in transformers in one embodiment. Of course, any type of network may be utilized, such as RNNs, LSTMs, transformers, Convolutional LSTMs (ConvLSTMs), Bidirectional RNNs (BRNNs), Gated Recurrent Units (GRUs), Deep Belief Networks (DBNs), and WaveNet, etc. Similarly, instead of using LSTMs, one could use any Recurrent Neural Network (RNN) Architecture. The aim is to capture correlations across time and then process these correlations with the third block, while taking advantage of the 2D (or multi-dimensional) representation obtained from the Wavenet CNN.

At production time various steps may be conducted. The ransomware monitor system continuously receives power consumption data from the target device. After each frame interval, the monitor preprocesses the data and prepares spectrograms. Each spectrogram is then converted into an embedding vector using the trained embedding model. Once a set of embedding vectors is collected, the monitor inputs them into the sequence model to generate a sequence probability. Based on a set of sequence probabilities, the upper ML models compute a decision score that may be utilized with a threshold to determine suspicious activity.

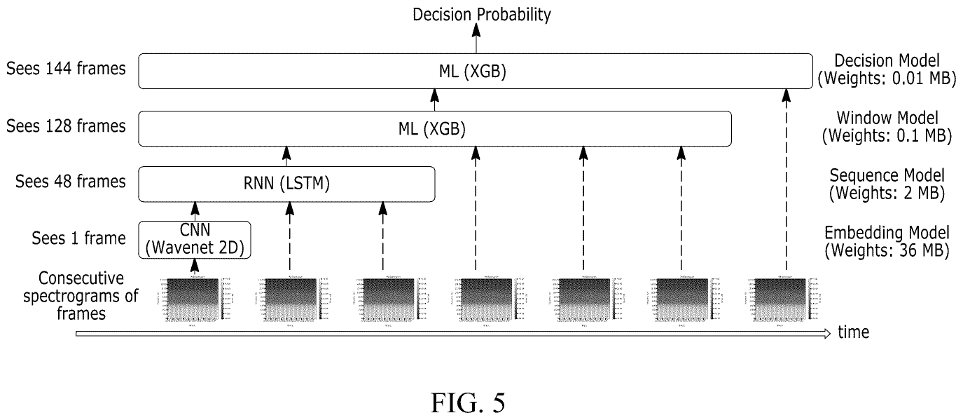

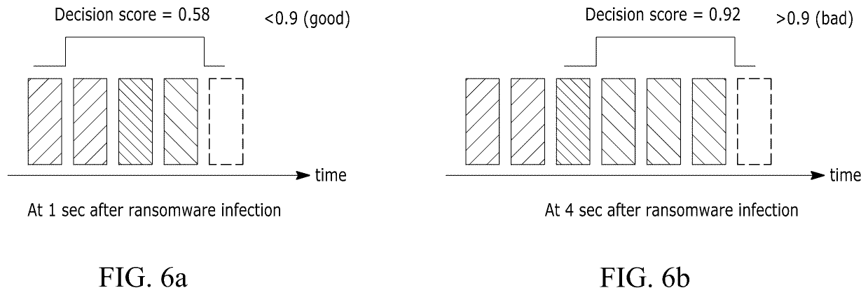

FIG. 6A is an example of a real-time sliding window-based detection mechanism after a first time period. Such a time period may be one second after a ransomware infection. FIG. 6B is an example of a real-time sliding window-based detection mechanism after a second time period. The second time period may be four seconds after a ransomware infection. As illustrated in FIGS. 6A and 6B, if the decision score exceeds a predetermined threshold, the monitor flags the trace as malicious and initiates necessary actions. The overall scheme operates similarly to a sliding window, continuously analyzing consecutive frames and outputting a score. The window can be configured to skip one or more frames after each decision, allowing for adjustable processing pace.

In an alternative embodiment, the system and method can introduce a sub-trigger at an intermediate threshold (e.g., 0.9 in FIGS. 6A and 6B) to alert the operator or a software agent on the target device to take preemptive measures, such as backing up recently opened files or slowing down suspicious processes. In the case of a ransomware attack, these preemptive actions can facilitate quicker recovery once the attack is detected.

As shown in FIG. 6A, the system may analyze the frames over time. In one scenario in FIG. 6A, two of the frames may indicate normal behavior, one may indicate questionable behavior, and one may indicate malicious behavior. But because the score is below a threshold value, the system cannot determine that there is malicious behavior at the target device.

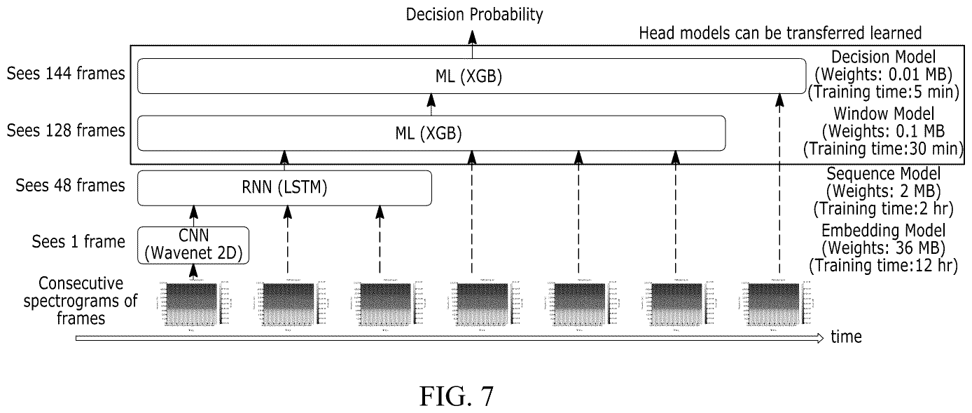

FIG. 7 illustrates an alternative embodiment of a model that can be transfer learned from the architecture of FIG. 5. The system may also propose a flexible detection pipeline such that the models can be independently updated. Oftentimes, the systems may want to update the models to include certain new benign workloads (to control false positives) or there might be some new zero-day ransomware which act differently from the ransomware that the system trained the models on. In such cases, it is not practical to keep updating all the models at once. For such purposes, the system and method may introduce-transfer learning-which states that updating the simpler models at the upper layers of the architecture, e.g., the ML models is sufficient to achieve reasonable accuracy. Transfer learning for a head model in machine learning may thus include the process of fine-tuning or adapting the head (the final layers) of a pre-trained model to a new task or dataset, while often keeping the lower layers (the feature extractor or “backbone”) frozen or partially trainable.

Since such models are lightweight, the training time for these would be significantly less than the lower models, making the detection architecture maintainable in the long run. The figure shows that the training time for the decision model (5 minutes) and window model (30 minutes) can be significantly less than the sequence model (2 hours) and embedding model (12 hours). Thus, the decision model and the window model may be transfer learned to identify new patterns or methods.

The transfer learning on the XGBoost model may be unique compared to other models. For example, the transfer learning may first train an XGBoost model on the new data set. Then the method may include extracting knowledge, such as identifying important features from the source model. Furthermore, the system may generate leaf embeddings for the target dataset utilizing a source model. The system may then train the new XGBoost model on the target dataset using the extracted features or leaf embeddings. In one embodiment, the system may optionally, initialize training with the trees or parameters from the source model. The system can evaluate and refine the adapted model on the new target task. This may include fine-tuning by adding more trees or adjusting hyperparameters.

The architecture for this embodiment, the head model (e.g. final layers or layers utilized for fine-tuning, etc.) may be utilized for transfer learning. This may be an advantage, as the system may train the head models, such as the decision model and the window model, on data collected from a set of general devices, and the system and method can transfer learn them to apply them to various other similar types of devices. This reduces the initial training time required for deploying our system. The system and method can quickly update the models in case of an emergency, rather than updating the entire architecture. And then later train the full pipeline (e.g., the embedding model or the sequence model), when there is more time to update end-to-end models.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for detecting ransomware on one or more target devices, comprising:
receiving training data from one or more training devices, wherein the training data includes side-channel power trace information associated with side-channel measurements from the one or more training devices;
preprocessing the training data, wherein the preprocessing includes sending the training data to a low-pass filter configured to remove abnormalities associated with the side-channel power trace information, cut each trace into a plurality of consecutive frames, and converting each of the plurality of frames into a one or more frequency-time representations;
sending the one or more frequency-time representations to an embedding model including a convolutional neural network configured to output one or more fixed-size embedding vectors utilizing the one or more frequency-time representations;
sending a consecutive set of the one or more fixed-size embedding vectors to a sequence model including a machine learning network configured to handle sequential data and further configured to output one or more probabilities indicating the consecutive set as benign or malicious;
sending, to a machine learning model, a continuous sequence of one or more probabilities from machine learning network configured to handle sequential data, wherein the machine learning model is configured to adjust parameters associated with the embedding model, the sequence model, and the machine learning model to output a final trained architecture output a final decision probability indicating ransomware presence in response to exceeding a probability threshold, wherein the final trained architecture is stored in a model database at a ransomware device;
receiving, at the ransomware device, real-time data from the one or more target devices in communication with the machine learning model, wherein the real-time data includes power trace information associated with the one or more target devices;
in response to comparing the real-time data to the model database, determining whether ransomware activity has occurred; and
in response to detecting ransomware activity occurring, executing a counterattack, wherein the counterattack includes shutting down operation at the one or more target devices.

2. The computer-implemented method of claim 1, wherein the method includes utilizing 256 Mel filters when converting each of the plurality of frames into the one or more frequency-time representations, wherein the one or more frequency-time representations includes one or more Mel spectrograms.

3. The computer-implemented method of claim 2, wherein the Mel spectrograms are representation of frequency spectrum across a frequency between 2 KHz and 16 KHz.

4. The computer-implemented method of claim 1, wherein the machine learning model includes recurrent neural networks (RNNs), long-short term memory network (LSTMs), transformers, Convolutional LSTMs, Bidirectional RNNs, Gated Recurrent Units, Deep Belief Networks, or WaveNet.

5. The computer-implemented method of claim 1, wherein the one or more frequency-time representations are include one or more Mel spectrograms, Mel-frequency cepstral coefficients, short-time fourier transform (STFT), gammatone-frequency cepstral coefficients (GFCC), constant-q transform (CQT), variable-q transform (VQT), or wavelet transform.

6. The computer-implemented method of claim 1, wherein the convolutional neural network (“CNN”), a RNN, and a prediction model are stacked above one another, and an upper model analyzes more frames than a lower model.

7. The computer-implemented method of claim 1, wherein each of the plurality of frames are 1 millisecond, 10 milliseconds, 30 milliseconds, 100 milliseconds, 200 milliseconds, or 1 second.

8. The computer-implemented method of claim 1, wherein the machine learning model has a sampling rate of less than 3 MHz.

9. The computer-implemented method of claim 1, wherein the embedding model has a sampling rate of less than 32 KHz.

10. A computer-implemented method for detecting ransomware on one or more target devices, comprising:
receiving, utilizing a power measurement device, real-time data from one or more devices, wherein the real-time data includes side-channel power trace information associated with side-channel measurements from the one or more devices;
preprocessing the real-time data, wherein the preprocessing includes sending the real-time data to a low-pass filter configured to remove abnormalities associated with the side-channel power trace information, cut each trace associated with the real-time data into a plurality of consecutive frames, and converting each of the plurality of frames into a one or more frequency-time representations;
sending the one or more frequency-time representations to an embedding model including a convolutional neural network configured to output one or more fixed-size embedding vectors utilizing the one or more frequency-time representations;
sending a consecutive set of the one or more fixed-size embedding vectors to a sequence model including a machine learning network configured to handle sequential data and further configured to output one or more probabilities indicating the consecutive set as benign or malicious;
sending, to a machine learning model, a continuous sequence of one or more probabilities from the machine learning network configured to handle sequential data;
outputting a final decision probability indicating ransomware presence in response to the continuous sequence of one or more probabilities exceeding a probability threshold; and
in response to the machine learning model detecting ransomware activity occurring, executing a counterattack at the one or more devices and recovering one or keys associated with the ransomware.

11. The computer implemented method of claim 10, wherein the machine learning model includes a recurrent neural networks (RNNs), long-short term memory network (LSTMs), transformers, Convolutional LSTMs, Bidirectional RNNs, Gated Recurrent Units, Deep Belief Networks, or WaveNet.

12. The computer implemented method of claim 10, wherein the machine learning model includes both a window model and a decision model, wherein the decision model is configured to output the final decision probability.

13. The computer implemented method of claim 10, wherein the machine learning network configured to handle sequential data includes a recurrent neural network includes a Long Short-Term Memory (LSTM) model.

14. The computer implemented method of claim 10, wherein the machine learning model is configured to be updated via transferred learning, but the sequence model and the embedding model are not.

15. The computer implemented method of claim 10, wherein the counterattack includes at least shutting down operation at the one or more devices, turning off power at the one or more devices, or disabling software at the one or more devices.

16. A computer-implemented method for detecting ransomware on one or more target devices, comprising:
receiving, utilizing a power measurement device, real-time data from one or more devices, wherein the real-time data includes side-channel power trace information associated with side-channel measurements from the one or more devices;
converting the side-channel power trace information to one or more Mel spectrograms;
sending the one or more frequency-time representations to an embedding model including a convolutional neural network configured to output one or more fixed-size embedding vectors utilizing the one or more frequency-time representations, wherein the convolutional neural network is further configured to utilize a consecutive set of the one or more fixed-size embedding vectors to output one or more probabilities indicating the consecutive set as benign or malicious;
sending, to a machine learning model, a continuous sequence of one or more probabilities from the convolutional neural network neural, wherein the machine learning model is configured to output a final decision probability indicating ransomware presence in response to exceeding a probability threshold; and
in response to detecting ransomware activity occurring, output an indication of ransomware activity at the one or more devices.

17. The method of claim 16, wherein the embedding model is configured to act as a sequence model configured to output probabilities.

18. The method of claim 16, wherein the embedding model is a Wavenet 2D model configured to extract features or embeddings from the one or more frequency-time representations.

19. The method of claim 16, wherein the converting includes preprocessing the real-time data, wherein the preprocessing includes sending the real-time data to a low-pass filter configured to remove abnormalities associated with the side-channel power trace information, cut each trace associated with the real-time data into a plurality of consecutive frames, and converting each of the plurality of frames into a one or more frequency-time representations;

20. The method of claim 16, wherein the method includes utilizing a recurrent neural network as an intermediary model between the convolutional neural network and the machine learning model.
